(19) United States
(12) Patent Application Publication
(10) Pub. No.: US 2026/0119889 A1
(43) Pub. Date: Apr. 30, 2026

(54) DEVICE AND METHOD OF NEXT TOKEN PREDICTION

(71) Applicant: Robert Bosch GmbH, Stuttgart (DE)

(72) Inventors: Metod Jazbec, Amsterdam (NL); Dan Zhang, Leonberg (DE)

(21) Appl. No.: 19/361,158

(22) Filed: Oct. 17, 2025

(30) Foreign Application Priority Data
Oct. 25, 2024 (DE) 10 2024 210 338.1

(51) Int. Cl. G06N 3/09; G06N 3/045; G06N 3/048; G06N 3/082

(52) U.S. Cl. CPC G06N 3/09; G06N 3/045; G06N 3/048; G06N 3/082

(57) ABSTRACT

A computer-implemented method of predicting a next token given a sequence of tokens by a transformer-based machine learning system. The method includes: processing an embedding of the sequence of tokens through multiple layers; determining a confidence score for individual tokens at a layer's output by multiplying the layer's output embedding with a weight matrix; at a predetermined pth layer, determining the K most likely next tokens; creating a pruned weight matrix by removing rows corresponding to other tokens; for predefined subsequent layers, determining a confidence score for only the K tokens using the pruned weight matrix; and returning the token with the highest confidence score exceeding a layer-specific threshold.

### CROSS REFERENCE

The present application claims the benefit under 35 U.S.C. § 119 of Germany Patent Application No. DE 10 2024 210 338.1 filed on Oct. 25, 2024, which is expressly incorporated herein by reference in its entirety.

### FIELD

The present invention relates to a computer implemented method of predicting a next token given a sequence of tokens, a corresponding system, a computer program, and a machine-readable storage medium.

### BACKGROUND INFORMATION

Increasing the size of large language models (LLMs) has been shown to lead to a better performance of these machine learning systems. However, this comes at the cost of slower and more expensive inference. “Early-exiting” as, e.g., described in arxiv.org/abs/2207.07061 is a promising approach for improving the efficiency of LLM inference by enabling token predictions at intermediate layers. A key component of early-exit models is the confidence score computed at every candidate exit, which determines whether the current prediction is of sufficient quality to terminate the forward pass and return the early prediction.

### SUMMARY

According to a first aspect, the present invention relates to a computer-implemented method of predicting a next token given a sequence of tokens by a transformer-based machine learning system. According to an example embodiment of the present invention, the machine learning system may receive a natural language input text, tokenize the input text into an initial sequence of tokens from its vocabulary, and then iteratively predict and append next tokens from its vocabulary to the (thereby evolving) sequence of tokens. Thereby, the evolving sequence of tokens comprises the tokenized input text and the so far predicted and appended next tokens. The evolving sequence of tokens may be the given sequence of tokens for the prediction of the next token according to the method described herein. Tokenizing may, in the given context, be understood as the process of decomposing a text into individual units, referred to as tokens, which may be words, sub-words, or characters, for processing by the machine learning system. Tokens may be selected or drawn from a vocabulary, wherein the vocabulary is the predefined set of all possible tokens the machine learning system recognizes and uses. The output of the machine learning system is a next token appended to the sequence of tokens. The process may be performed iteratively, such that the original input sequence may be effectively extended. Each iteration of the method may add one new token. The iterative process of token generation may stop when, e.g., a maximal number of appended next tokens is reached or, e.g., another termination criterium is met.

According to an example embodiment of the present invention, the machine learning system may further determine an embedding of the sequence of tokens and processes said embedding through a plurality of layers. A layer out of the plurality of layers of the transformer-based machine learning system in context of the description herein may be understood as a composite/modular block comprising several subcomponents. Such subcomponents may, e.g., comprise attention layers, feed-forward operations, residual connections, layer normalization and/or convolutional layers. Accordingly, the notion of a layer of the transformer-based machine learning system may be understood as a higher-level building block of the machine learning system. Particularly, a layer (of the transformer-based machine learning system) as referred to herein may comprise at least a multi-head attention block and/or a feed-forward block.

According to an example embodiment of the present invention, an embedding of the sequence of tokens may comprise the embeddings, i.e. numerical (vector) representations of each of the elements of the sequence of tokens. Hence, by embedding (elements of) a sequence of tokens, the respective discrete textual units are mapped into a continuous vector space that may, e.g., capture semantic and contextual relationships between the tokens. This vector representation may then be processed by the layers of the transformer-based model.

A confidence score for individual tokens out of the vocabulary of tokens is determined at the output of specific, predetermined layers. The confidence score for an individual token is given by a corresponding entry of a confidence score vector determined by multiplying the specific layer's output embedding with a weight matrix. The weight matrix may be learned during training of the machine learning system. In embodiments, a confidence score may be determined at the output of each layer, such that each layer may be, in those embodiments, a “specific, predetermined layer”. However, in other embodiments, specific, but not all, layers may be predetermined, and only for those predetermined layers a confidence score for individual tokens may be determined at the respective layer's output. For example, in other embodiments, every second or every third layer may be a specific, predetermined layer. In such cases, the overall computational costs of the determination of the confidence scores may be reduced, as a confidences score may not be determined at the output of each layer. In other words, a “specific” layer in this context may refer to a layer predetermined during the design or set up of the architecture of the machine learning system; which layers out of the plurality of layers of the machine learning system are chosen/determined as specific layers may depend on design choice and/or overall computational costs.

The confidence score may be understood as a measure how certain the machine learning system is that a corresponding token is the next token.

According to an example embodiment of the present invention, the method comprises the following steps: For a predetermined pth layer of the machine learning system, the K tokens are determined that are most likely the next token, based on their respective confidence score calculated from the output of the pth layer. I.e., the K tokens corresponding to the elements of the confidence score vector with the top K highest values are determined. In a subsequent step, a pruned weight matrix is determined from the weight matrix by removing in the weight matrix all rows but those rows corresponding to the determined K most likely tokens. In removing, i.e., deleting, all rows but those corresponding to the K identified tokens, the dimension of the pruned weight matrix may be drastically reduced, depending on the concrete choice of K. When e.g., the vocabulary comprises over 30.000 or even 50.000 tokens, choosing K to take a value between one or several hundred gives an extreme reduction in complexity (regarding time and storage resources) for calculation steps involving the pruned weight matrix instead of the (unpruned) weight matrix.

In a next step, a confidence score for only the determined K most likely tokens is determined for specific layers subsequent to the pth layer. This may be done by determining a pruned confidence score vector determined by multiplying the output embedding of the respective layer with the pruned weight matrix. Similarly, as above, the layers subsequent to the pth layer, for which the confidence score (now: the confidence score for only the determined K most likely tokens) is determined, may comprise all subsequent layers up to a final layer, or, in other embodiments, only specific, predetermined subsequent layers. Finally, the token corresponding to the highest confidence score in the pruned confidence score vector obtained from the output embedding of a certain layer may be returned as the next token, when said highest confidence score exceeds a predefined layer-specific threshold of that layer. Particularly, the processing of a layer's output embedding by all the subsequent layers may be terminated/cancelled or not be started at all, when said highest confidence score exceeds the predefined layer-specific threshold of that layer. The returned next token may then be appended to the (thereby evolving) sequence of tokens and the steps for predicting a next token given the (evolving) sequence of tokens may start again. It may be noted that a layer specific threshold may be given by a shared, common value for all layers of the machine learning system, in such case rather denoting a predefined threshold. The predefined (layer-specific) threshold may be determined during training of the machine learning system. A possible value for a (layer-specific) threshold may be, e.g., a value slightly smaller than 1, e.g., 0.9, which would signify that the model should be very confident in its prediction before outputting a next token. However, also a lower threshold, e.g., 0.5, may be chosen. Specific values may have been determined empirically during training and tuning of the machine learning system based on desired performance characteristics. In other embodiments, a calibration of the confidence score may not be mandatory. Instead, the confidence score may only allow a proper ranking by scoring possible tokens higher than less possible tokens. Then, e.g., based on a validation data set, a value for a (layer-specific) threshold may be set, accordingly.

It may be noted further that the embeddings of all elements of the sequence of tokens may be processed by the machine learning system, while, however, only the embedding corresponding to the last token in the sequence of tokens may be used in the mapping with the weight matrix or the pruned weight matrix.

Advantageously, the method according to the present invention increases efficiency in transformer-based token prediction by pruning less likely tokens from consideration in later layers. This reduces computational overhead, i.e., saves computational costs, without significant loss of accuracy, enabling faster and less resource-intensive text generation. In other words, the method described herein allows for efficient estimation of confidence at every layer output. When considering mapping the respective layer's output embeddings (hidden representations) to the full token space (i.e., vocabulary), this would introduce a significant overhead to the forward pass of the transformer-based machine learning system.

Further, advantageously, the method described herein may make the inference of an arbitrary machine learning system for next-token prediction, i.e., a large language model (LLM), faster by dynamically pruning the weight matrix that maps the hidden representation to the logits, previously referred to as token scores, over tokens.

While the large vocabulary size in modern LLMs may make the confidence estimation required for early exit decisions computationally expensive, diminishing the realized efficiency gains, the method proposed herein may help to overcome/alleviate this issue. Thereby, an early exit decision may be described as the decision of returning a token, predicted by the output of an intermediate layer, as the next token, without then further following the forward pass of the machine learning system.

The method described herein is, in particular, independent of the exact architecture or training style of the machine learning system, or the input text provided to/received by the machine learning system.

Preferably, according to an example embodiment of the present invention, the confidence score vector, or the pruned confidence score vector, respectively, may be determined as the softmax of the product of the weight matrix, or pruned weight matrix, and the output embedding of the respective layer. In particular, the weight matrix/the pruned weight matrix may map a layer's output embedding to a vector of token scores. The token scores (sometimes referred to as logits) may be interpreted or described as “raw”, unnormalized scores for each token/the K most likely tokens in the vocabulary. The token scores are then transformed by a softmax function into a probability distribution over the vocabulary, representing the confidence scores for each token.

The weight matrix may have been determined during training of the machine learning system as the unembedding matrix at the last layer of the machine learning system. It may be noted that the softmax function may transform the vector of raw token scores (logits) into a probability distribution, where each element represents the probability of a corresponding token, and all elements sum to one.

A definition of the (unit) softmax function may be given by

$$softmax {( {h}_{k}^{l} )}_{i} = \frac{{e}^{{h}_{{k}_{i}}^{l}}}{{\sum }_{j}^{{d}_{model}} {h}_{{k}_{j}}^{l}}$$

$$with {h}_{k}^{l} ∈ {ℝ}^{{d}_{model}}$$

denoting an embedding.

It may be noted that p and K may take values defined by natural numbers smaller than the total number of layers and the total number of tokens of the vocabulary of the machine learning system, respectively. Accordingly, p and K are hyperparameters and may be defined/chosen/set by a user or may be determined by another algorithmic method in advance.

Preferably, according to an example embodiment of the present invention, the layers in the plurality of layers of the transformer-based machine learning system are decoder layers. Each decoder layer may comprise a multi-head attention block and a feedforward block.

Preferably, the values of p and K may be optimized by evaluating the machine learning system on a validation dataset with different values of p and K, respectively, and by selecting the values of p and K that maximize a performance metric. The performance metric may in this context measure a deviation between an output of the machine learning system and a corresponding element of the validation data set.

Advantageously, such optimization of p and K based on a performance metric measuring deviation between output and validation data may lead to improved accuracy and efficiency in next-token prediction, particularly by tailoring the pruning strategy to the specific characteristics of the data, reducing computational cost without significant loss of predictive performance.

Preferably, the method steps may be executed by the processor of a device, wherein the value of K and/or the value of p are determined based on the specific hardware resources of the device. Hardware resource may comprise available processing power and/or available memory. The device may, e.g., be a resource constrained device. Such device may be limited in computational capacity, which may be measured in FLOPS (floating-point operations per second), available RAM (random access memory), and/or constrained power consumption measured in watts. Such device may, in particular, necessitate optimized algorithms and potentially reduced model sizes to accommodate resource limitations. Accordingly, a smaller K and/or a smaller p may be selected for devices with more limited resources, and a larger K and/or a larger p may be selected for devices with greater resources. In particular, the values p and/or K may be determined such that performance within the device's constraints is optimized. Examples for resource constrained devices may include a mobile device, a personal computer, or a laptop, as well as an electronic control unit in a vehicle, robot, or manufacturing machine.

Advantageously, adapting p and K to the specific, available hardware resources may enable efficient execution of the next-token prediction method on a wider range of specific devices, including resource-constrained devices, by balancing prediction accuracy with computational cost and memory usage. This may allow for deployment on devices with limited processing power, memory, or battery life.

Preferably, according to an example embodiment of the present invention, the machine learning system may be part of a multimodal machine learning system that receives sensor data recorded by a corresponding sensor and, optionally, text data as input. Sensor data may be recorded by a corresponding sensor such as a (video-) image sensor, e.g., a camera, a RADAR, LiDAR, temperature, or ultrasound sensor. The multimodal machine learning system may process the sensor data based on low level features, e.g., edges or pixels of (video-) images. The machine learning system may then be prompted (i.e. instructed via an input text) to generate a textual classification of the received sensor data using the method for predicting a next token given a sequence of tokens. An actor of a robot, a manufacturing machine, or a part of a manufacturing machine a may be controlled based on the generated textual classification.

A textual classification may comprise a textual label indicating whether the received sensor data conforms to a predefined criterion within predefined boundaries, the label being either “OK” or “Not OK”. Alternatively, the textual classification may comprise a description of characteristics of the sensor data. In this case, the machine learning system may have been prompted accordingly. In other words, the token prediction method may generate a sequence of tokens forming a textual description of the sensor data. This description may then be compared to predefined criteria for “OK” and “Not OK” states. If the generated description matches the “OK” criteria, the classification is “OK”; otherwise, it's “Not OK.” An actor may, e.g., be a motor, a robotic arm or a valve.

In an exemplary case, where the generated textual classification is “OK,” the actor (e.g., robotic arm) may continue its programmed operation. On the other hand, in this example, if the classification is “Not OK,” the actor may be instructed to stop or to perform a corrective action. Such control logic may, e.g., be implemented through a control system that receives the textual classification as input and triggers corresponding commands to the actor.

It may be noted that an aforementioned configuration may, as an example, be realized by using a CLIP (Contrastive Language Image Pretraining)-like framework as the multimodal machine learning system, wherein an image (more generally: sensor data) encoder component of the multimodal machine learning system could produce an embedding, and the text encoder could be realized by the machine learning system described herein, which could generate the most likely caption given the (embedding of the) image (more generally: sensor) data, i.e. the tokens “OK” or “Not OK”.

According to a further aspect, the present invention relates to a system comprising a processor configured to perform a method of predicting a next token according to the present invention as described herein.

According to a further aspect, the present invention relates to a computer program comprising machine-readable instructions, which, when the program is executed by a computer, cause the computer to carry out one of the computer-implemented methods of the present invention described above and below. Furthermore, according to another aspect, the present invention relates to a machine-readable storage medium, on which the above computer program of the present invention is stored.

Example embodiments of the present invention will be discussed with reference to the figures in more detail.

### BRIEF DESCRIPTION OF THE DRAWINGS

FIG. 1 shows a flow chart of an exemplary embodiment of the present invention.

FIG. 2 shows a flow chart of an exemplary embodiment of the present invention.

### DETAILED DESCRIPTION OF EXAMPLE EMBODIMENTS

For illustrative purposes in the following description of embodiments, let Y denote the vocabulary space of the machine learning system, with size |Y|=d_{vocab}. Further, let (x₁, . . . , xₜ), xᵢ∈Y represent the given sequence of tokens, comprising both the tokenized input text and the so far predicted and appended tokens.

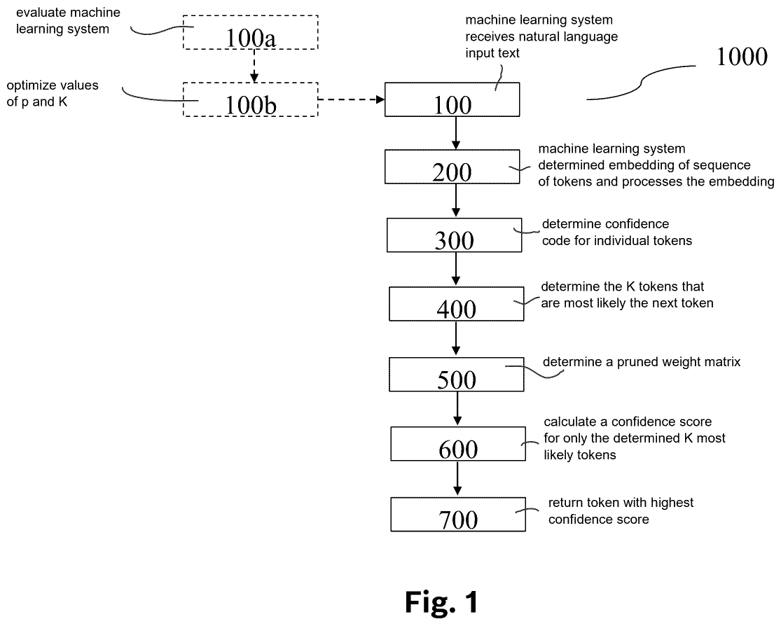

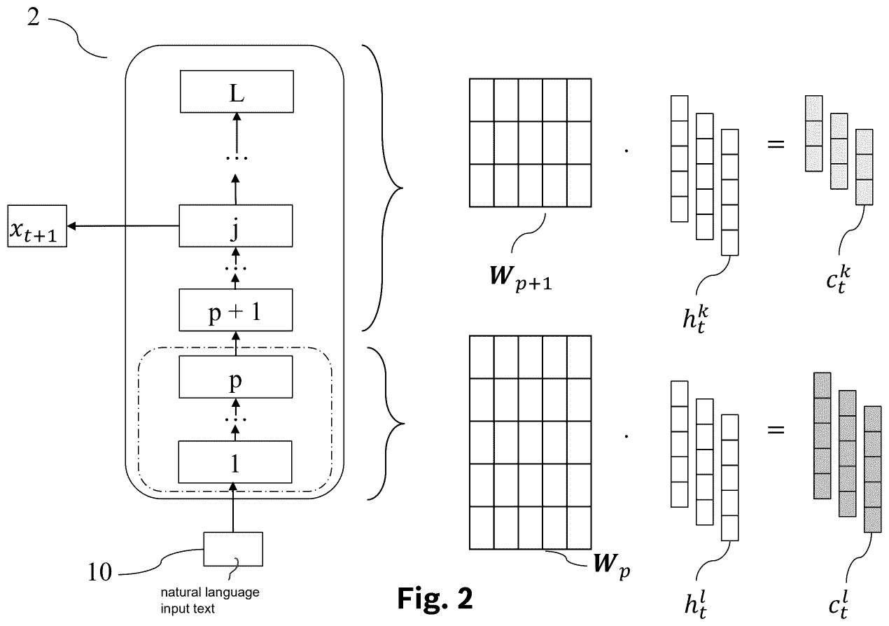

FIG. 1 shows a flow-chart of method steps according to an embodiment. In step 100, machine learning system 2 (with reference to FIG. 2) receives natural language input text 10. This input text is tokenized into an initial sequence of tokens from the machine learning system's vocabulary, and machine learning system 2 iteratively predicts and appends next tokens from its vocabulary to the evolving sequence of tokens. In particular, the initial sequence of tokens may be given by (x₁, x₂, . . . , xᵢ), and after (some/several) steps of iteration, the evolving sequence of tokens may be given by (x₁, x₂, . . . , x₁, xᵢ₊₁, . . . , xₜ). It should be noted, that for the method described herein, the sequence may coincide with the initial sequence or may be given by the sequence after some/several iterations. For notational purposes, the sequence will be denoted by (x₁, x₂, . . . , xₜ) in the following, and t=i or t>i.

In a next step 200, machine learning system 2 determines an embedding of the sequence of tokens and processes said embedding through a plurality of layers. Exemplarily, layer 1, p, p+1, j, and L are shown in FIG. 2. A confidence score for individual tokens out of the vocabulary is then determined in step 300 at the output of specific layers. The confidence score for an individual token is given by a corresponding entry of confidence score vector

$${c}_{t}^{l} ( {c}_{t}^{k} ) ,$$

determined by multiplying the layer's output embedding

$${h}_{t}^{l} ( {h}_{t}^{k} )$$

with weight matrix Wₚ (Wₚ₊₁), see also FIG. 2. In method step 400, for predetermined layer p, the K tokens being most likely the next token based on their respective confidence score are determined, wherein the confidence score is calculated from the output embedding

$$( {h}_{t ′}^{l} )$$

of layer p. In subsequent step 500, pruned weight matrix Wₚ₊₁ is determined from weight matrix Wₚ by removing in weight matrix Wₚ all rows but those rows corresponding to the determined K most likely tokens. For layers subsequent to the layer p, a confidence score for only the determined K most likely tokens is calculated in step 600. This is done by determining pruned confidence score vector

$${c}_{t}^{k}$$

determined by multiplying output embedding

$${h}_{t}^{k}$$

of the respective layer with pruned weight matrix Wₚ₊₁. In step 700, the token corresponding to the highest confidence score in the pruned confidence score vector is returned as next token xₜ₊₁, when said highest confidence score exceeds a predefined layer-specific threshold of that layer (layer j in FIG. 2).

Optionally, values of p and K are optimized in steps 100a and 100b. In step 100a, the machine learning system is evaluated on a validation dataset with different values of p and K, respectively. Subsequently, in step 100b, those values of p and K are selected, that maximize a performance metric.

With further reference to FIG. 2, an embodiment of the method is shown in a flowchart. Machine learning system 2 comprises a transformer architecture, see arxiv.org/abs/1706.03762. Generally, in a transformer model, the input sequence is passed through L layers, each consisting of a multi-head attention and a feed-forward block, yielding a sequence of hidden representations

$${\{ {h}_{t}^{l} \}}_{l = 1}^{L} , with {h}_{t}^{l} ∈ {ℝ}^{{d}_{model}} ,$$

wherein d_{model} denotes the dimension of the embedding space. After processing through all layers, the final next token distribution may be obtained via

$$p ( {x}_{t + 1} \vert {h}_{t}^{L} ) = soft max ( {Wh}_{t}^{L} ) .$$

This distribution is a vector that may, with reference to FIG. 2, also be denoted by

$${c}_{t}^{L} .$$

W∈ [symbol] may, generally, in a transformer-based machine learning system, denote the weight matrix, also referred to as the unembedding matrix, that may project the final hidden state

$${h}_{t}^{L}$$

back to the token space Y. Newly predicted token xₜ₊₁ is then added to the input sequence, and the (autoregressive) generation process may be repeated until a predetermined termination criterion is met.

It may be noted that only embedding

$${h}_{t}^{L}$$

referring to the last token xₜ in the sequence of tokens may be considered when determining

$$p ( {x}_{t + 1} \vert {h}_{t}^{L} ) = soft max ( {Wh}_{t}^{L} ) .$$

This may imply the assumption, that knowledge about the further, preceding tokens in the sequence of tokens is encoded in the hidden representation (i.e. embedding) of the last token

$${h}_{t}^{L}$$

through the attention mechanism.

Machine learning system 2 in FIG. 2 may predict and return next token xₜ₊₁ already at some intermediate layer j, also known as early exiting, if the machine learning system is sufficiently confident. A confidence score for individual tokens may be defined by the corresponding entry of confidence score vector

$${c}_{t}^{l} ,$$

where index l refers to the respective layer. A criterion for early exiting in layer j may then be given by

$$max ( {c}_{t}^{j} ) > {λ}_{t}^{j} ,$$

wherein

$${λ}_{t}^{j}$$

denotes the layer-specific threshold. It may be noted, that

$${c}_{t}^{j} = p ( {x}_{t + 1} \vert {h}_{t}^{j} ) = soft max ( {W}_{p + 1} {h}_{t}^{j} )$$

in the case of machine learning system 2. For the first p layers, (l=1, . . . , p), in machine learning system 2, confidence score vector

$${c}_{t}^{l}$$

is determined by

$${c}_{t}^{l} = p ( {x}_{t + 1} \vert {h}_{t}^{l} ) = soft max ( {W}_{p} {h}_{t}^{l} ) .$$

From the confidence vector

$${c}_{t}^{p} ,$$

i.e. the softmax of the product of weight matrix Wₚ and layer output

$${h}_{t}^{p} ,$$

the K tokens being most likely the next token are determined as the K tokens with the highest probabilities according to their respective entries in the confidence vector. For subsequent layers, in the calculation of the confidence score vectors, the pruned weight matrix Wₚ₊₁ is used, determined from weight matrix Wₚ by removing all rows but those rows corresponding to the determined K most likely tokens. By choosing K<<d_{vocab}, the cost of confidence estimation is significantly reduced, while it has been observed, however, that the performance may stay roughly the same, which may, optionally, also be further optimized by adjusting p. From the perspective of computational cost savings, a smaller value of p may be preferable, however, then it has to be made sure that with a sufficient likelihood, the next token to be predicted is indeed among the K most likely tokens. The combination of the dynamic early exiting after layer j, depending on the confidence for a token to be the next token exceeding a threshold, together with the—from a certain layer on—pruned and therewith much smaller weight matrix may lead to significant improvement with respect to required memory and processing power.

Finally, it may be noted that, in general, a plurality can be understood to be indexed, as has been made use of throughout here. That is, each element of the plurality may be assigned a unique index, preferably by assigning consecutive integers to the elements contained in the plurality. Preferably, if a plurality comprises N elements, wherein N is the number of elements in the plurality, the elements are assigned the integers from 1 to N. It may also be understood that elements of the plurality can be accessed by their index.

What is claimed is:

1. A computer-implemented method of predicting a next token given a sequence of tokens by a transformer-based machine learning system, wherein the machine learning system receives a natural language input text, tokenizes the input text into an initial sequence of tokens from a vocabulary of the machine learning system, and iteratively predicts and appends next tokens from the vocabulary of the machine learning system to the sequence of tokens, wherein the machine learning system determines an embedding of the sequence of tokens and processes the embedding through a plurality of layers, wherein a layer out of the plurality of layers includes at least a multi-head attention block and/or a feed-forward block, wherein a respective confidence score for individual tokens out of the vocabulary is determined at an output of specific respective layers, wherein the respective confidence score for an individual token is given by a corresponding entry of a confidence score vector determined by multiplying the respective specific layer's output embedding with a weight matrix, and wherein the method comprises the following steps:
determining, for a predetermined pth layer, K tokens most likely to be the next token based on the respective confidence score calculated from an output of the pth layer;
determining a pruned weight matrix from the weight matrix by removing from the weight matrix all rows other than those rows corresponding to the determined K most likely tokens;
determining for specific layers subsequent to the pth layer a confidence score for only the determined K most likely tokens by determining a pruned confidence score vector determined by multiplying the output embedding of the respective layer with the pruned weight matrix; and
returning the token of the determined K most likely tokens corresponding to a highest confidence score in the pruned confidence score vector as the next token, when the highest confidence score exceeds a predefined layer-specific threshold of that layer.

2. The method according to claim 1, wherein the pruned confidence score vector is determined as a softmax of a product of the pruned weight matrix and the output embedding of the respective layer.

3. The method according to claim 1, wherein p and K take values defined by natural numbers smaller than a total number of layers and a total number of tokens of the vocabulary of the machine learning system, respectively.

4. The method according to claim 1, wherein each layer in the plurality of layers is a decoder layer, wherein each decoder layer including a multi-head attention block, and a feedforward block.

5. The method according to claim 3, wherein the values of p and K are optimized by:
evaluating the machine learning system on a validation dataset with different values of p and K, respectively, and
selecting the values of p and K that maximize a performance metric.

6. The method according to claim 3, wherein the method steps are executed by the processor of a device, wherein the value of K and/or the value of p are determined based on the specific hardware resources of the device.

7. The method according to claim 1, wherein the machine learning system is part of a multimodal machine learning system that receives sensor data recorded by a corresponding sensor and, text data as input, wherein the machine learning system generates a textual classification of the received sensor data, and wherein an actor of a robot or a manufacturing machine or a part of a manufacturing machine is controlled based on the generated textual classification.

8. A data processing system, comprising:
a processor configured to perform a method of predicting a next token given a sequence of tokens by a transformer-based machine learning system, wherein the machine learning system receives a natural language input text, tokenizes the input text into an initial sequence of tokens from a vocabulary of the machine learning system, and iteratively predicts and appends next tokens from the vocabulary of the machine learning system to the sequence of tokens, wherein the machine learning system determines an embedding of the sequence of tokens and processes the embedding through a plurality of layers, wherein a layer out of the plurality of layers includes at least a multi-head attention block and/or a feed-forward block, wherein a respective confidence score for individual tokens out of the vocabulary is determined at an output of specific respective layers, wherein the respective confidence score for an individual token is given by a corresponding entry of a confidence score vector determined by multiplying the respective specific layer's output embedding with a weight matrix, and wherein the method includes the following steps:
determining, for a predetermined pth layer, K tokens most likely to be the next token based on the respective confidence score calculated from an output of the pth layer;
determining a pruned weight matrix from the weight matrix by removing from the weight matrix all rows other than those rows corresponding to the determined K most likely tokens;
determining for specific layers subsequent to the pth layer a confidence score for only the determined K most likely tokens by determining a pruned confidence score vector determined by multiplying the output embedding of the respective layer with the pruned weight matrix; and
returning the token of the determined K most likely tokens corresponding to a highest confidence score in the pruned confidence score vector as the next token, when the highest confidence score exceeds a predefined layer-specific threshold of that layer.

9. A non-transitory computer-readable data carrier on which is stored a computer program including instructions for predicting a next token given a sequence of tokens by a transformer-based machine learning system, wherein the machine learning system receives a natural language input text, tokenizes the input text into an initial sequence of tokens from a vocabulary of the machine learning system, and iteratively predicts and appends next tokens from the vocabulary of the machine learning system to the sequence of tokens, wherein the machine learning system determines an embedding of the sequence of tokens and processes the embedding through a plurality of layers, wherein a layer out of the plurality of layers includes at least a multi-head attention block and/or a feed-forward block, wherein a respective confidence score for individual tokens out of the vocabulary is determined at an output of specific respective layers, wherein the respective confidence score for an individual token is given by a corresponding entry of a confidence score vector determined by multiplying the respective specific layer's output embedding with a weight matrix, the instructions when executed by a computer, causing the computer to perform the following steps comprising:
determining, for a predetermined pth layer, K tokens most likely to be the next token based on the respective confidence score calculated from an output of the pth layer;
determining a pruned weight matrix from the weight matrix by removing from the weight matrix all rows other than those rows corresponding to the determined K most likely tokens;
determining for specific layers subsequent to the pth layer a confidence score for only the determined K most likely tokens by determining a pruned confidence score vector determined by multiplying the output embedding of the respective layer with the pruned weight matrix; and
returning the token of the determined K most likely tokens corresponding to a highest confidence score in the pruned confidence score vector as the next token, when the highest confidence score exceeds a predefined layer-specific threshold of that layer.
